(19) United States
(12) Patent Application Publication
(10) Pub. No.: US 2011/0018526 A1
(43) Pub. Date: Jan. 27, 2011

(54) MEASURING DEVICE FOR MEASURING RELATIVE ROTATIONAL SPEEDS USING WIRELESS SIGNAL TRANSFER

(76) Inventors: Tobias Windmueller, Muenchen (DE); Mathias Schleyer, Kempten (DE)

Correspondence Address: KENYON & KENYON LLP, ONE BROADWAY, NEW YORK, NY, 10004, US

(21) Appl. No.: 12/735,736

(22) PCT Filed: Feb. 11, 2009
(86) PCT No.: PCT/EP2009/000940

§ 371 Date: Oct. 13, 2010

(30) Foreign Application Priority Data
Dec. 2, 2008 (DE) 102008008720.3

(51) Int. Cl. G01P 3/44

(52) U.S. Cl. 324/176

(57) ABSTRACT

A measuring device for measuring the relative rotational speed of a rotor which rotates with respect to a stator, having at least one inductive pulse generator which is supported by the stator and comprises at least one induction coil in which an electrical voltage which represents a rotational speed measurement signal for the rotational speed is induced by the rotation of the rotor provided with circumferential markings.

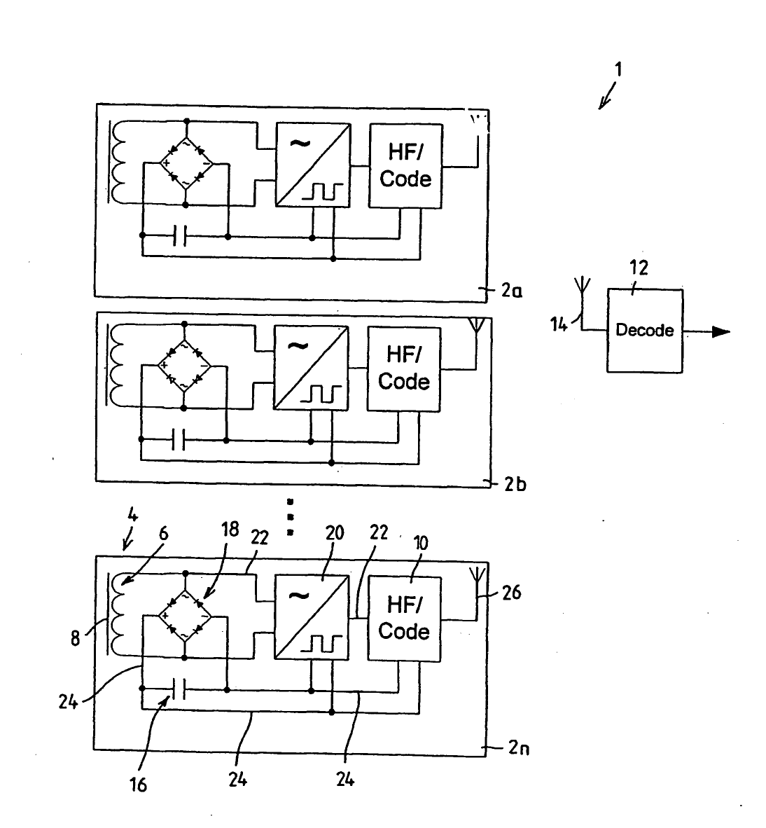

### FIELD OF THE INVENTION

The present invention relates to a measuring device for measuring the relative rotational speed of a rotor which rotates with respect to a stator, having at least one inductive pulse generator which is supported by the stator and comprises at least one induction coil in which an electrical voltage which represents a rotational speed measurement signal for the rotational speed is induced by the rotation of the rotor provided with circumferential markings.

### BACKGROUND INFORMATION

An inductive pulse generator is discussed, for example, in Kraftfahrtechnischen Taschenbuch (automotive handbook), Robert Bosch GmbH, pages 136 to 139, Friedrich Vieweg & Sohn Verlag, 26th edition, January 2007. When such incremental detection of the relative rotational speed is carried out, the rotating element or the rotor has a number of circumferential markings, usually in the form of teeth of a gearwheel, with each tooth bringing about a change in the voltage induced in the induction coil supported by the stator. An evaluation electronics unit then calculates the relative rotational speed of the rotor relative to the stator from the number of circumferential markings scanned per time unit. In this context, the rotor can be composed of magnetically passive material such as, for example, soft-magnetic iron. In this case, the induction coil of the stator is wound around a pole pin to which a magnet made of hard-magnetic material is attached. The rotor can alternatively also be composed of hard-magnetic material, with the individual teeth of the gearwheel having, for example, an alternating magnetic polarity.

The known inductive pulse generators have in common the fact that they are connected by at least one electrical signal line to the evaluation device which is usually accommodated in a control unit. In modern vehicles, such rotational speed sensors are used, for example, for measuring wheel speeds within the scope of an ABS/traction control or ESP system, crankshaft rotational speeds and/or camshaft rotational speeds and/or rotational speeds of an injection pump and are therefore correspondingly present in large numbers, which requires corresponding cost-intensive cabling in order to connect the rotational speed sensors to the respective evaluation device, for example to an ABS control unit.

### SUMMARY OF THE INVENTION

An object of the exemplary embodiments and/or exemplary methods of the present invention is, in contrast, to develop a measuring device of the type mentioned at the beginning in such a way that it can be mounted more easily and more cost-effectively.

This object is achieved according to the exemplary embodiments and/or exemplary methods of the present invention by the features described herein.

The exemplary embodiments and/or exemplary methods of the present invention is based on the idea that a transmitting device which can be supplied with the electrical energy based on the voltage induced by the inductive pulse generator is provided, which transmitting device transmits at least the rotational speed measurement signal or a signal derived therefrom to a receiving device in a wireless fashion.

The voltage induced in the induction coil of the inductive pulse generator therefore carries out a dual function by virtue of the fact that, on the one hand, it carries at least the rotational speed measurement signal, for example as a signal frequency, and, on the other hand, at the same time supplies the electrical energy for operation of the transmitting device for the wireless transmission of at least the rotational speed measurement signal, or the signal derived therefrom, to the receiving device. This signal which is derived from the rotational speed measurement signal may be, for example, the evaluated rotational speed measurement signal if an evaluation device for the rotational speed measurement signal is already present at the transmitter end, which evaluation device generates from said rotational speed measurement signal the actual rotational speed as a ready input variable for a control unit.

Because of the wireless data transmission of the measurement signals from the transmitting device to the receiving device, the previously customary cabling between the inductive pulse generator and the target device of the measurement signals, for example an ABS, traction control system, ESP or engine control unit, can be dispensed with, as a result of which the mounting costs for the measuring device according to the exemplary embodiments and/or exemplary methods of the present invention are advantageously low.

As a result of the measures specified in the description herein, advantageous developments and improvements of the exemplary embodiments and/or exemplary methods of the present invention specified in the description herein are possible.

An energy store which can be charged by the induced voltage may particularly be provided for supplying energy to the transmitting device. This energy store includes, for example, at least one maintenance-free capacitor or an accumulator such as, for example, an NIMH, Li-ion or Li polymer accumulator. In order to permit such an energy store to be charged, a pulse shaper may be present for shaping the alternating voltage, generated by the induction coil, into a direct voltage for the energy store. The excess energy which is present during relatively rapid rotation of the rotor is then stored in the energy store and can be used for operation at a relatively low rotational speed of the rotor and therefore for generating relatively small amounts of energy.

Furthermore, the inductive pulse generator can interact with a signal-conditioning device for converting the analog rotational speed measurement signal into a square-wave signal or an encoded data signal.

At least the inductive pulse generator, the energy store, the pulse shaper, the signal-conditioning device and the transmitting device are then particularly may be combined in a combined sensor/transmitting unit which is arranged in the direct vicinity of the rotor. In addition, the signal-evaluating device can also be integrated into this unit, which signal-evaluating device evaluates the square-wave signal which is modulated by the signal-conditioning device, and generates therefrom the actual rotational speed signal which can be processed directly by a control unit. However, if it is necessary, owing to, for example, high temperature loading in the region of the rotor, to remove one or more elements from such a sensor/transmitting unit apart from the inductive pulse generator, which always has to be arranged at the rotor, these removed elements can be coupled to the inductive pulse generator by a cable connection.

If the inductive pulse generator is a rotational speed sensor for measuring wheel speeds within the scope of an ABS/traction control or ESP system, crankshaft rotational speeds and/or camshaft rotational speeds and/or rotational speeds of an injection pump of a vehicle, such a combined sensor/transmitting unit is then arranged, for example, in the direct vicinity of each vehicle wheel or each vehicle axle or of the crankshaft, the camshaft or the injection pump and transmits the rotational speed measurement signal of the respective rotor to a, for example, central receiving device, from which the rotational speed measurement signals are then distributed or passed on to control devices which are responsible for the respective functions such as ABS, traction control, ESP, engine control, mixture preparation etc. However, it is alternatively also possible for a separate receiving device to be provided for each combined sensor/transmitting unit or for a group of combined sensor/transmitting units. Last but not least, such a receiving device can also be integrated directly into a control unit, or an already existing receiving device (for example ZV, Keyless Go®, TPMS®) is used.

According to one exemplary embodiment, the transmitting device and the receiving device are part of an RFID system with an active or passive transponder or a similar close-range radio system such as, for example, Bluetooth® or ZigBee®.

A passive transponder of a radio frequency identification system (RFID) does not require its own power supply to carry out functions. Instead, the reading device of the RFID system, here the receiving device, generates a high-frequency electromagnetic alternating field which illuminates the antenna of the RFID transponder. An induction current is produced in an antenna coil of the transponder as soon as the electromagnetic field of the reading device detects said antenna coil. This induction current is rectified and a capacitor is therefore charged as a short-term accumulator, which performs the function of supplying power to a microchip for the reading process. The microchip which is activated in this way in the transponder receives commands from the reading device (receiving device), which the latter modulates into its electromagnetic field. The microchip generates a response and modulates the field emitted by the reading device (receiving device) by field attenuation in the contact-free short-circuit or by reflection.

Such a transponder is consequently composed of a microchip, an antenna, a carrier or housing and an energy source which is formed by a capacitor in the case of passive transponders. Passive transponders consequently draw their energy for supplying the microchip from the received electromagnetic waves (continuous wave) of the reading device (receiving device). The antenna coil is used to charge the capacitor by induction, similarly to in a transformer, said capacitor supplying the microchip with electrical energy. The continuous wave has to be transmitted continuously by the reading device (receiving device) due to the small capacitance of the capacitor, while the transponder is in the reading region or illumination region. The range is from a few millimeters up to several centimeters, for which reason the distance between the combined sensor/transmitting unit, containing such a passive transponder and the inductive pulse generator, on the one hand, and the reading device (receiving device), on the other, is relatively small and the saving in terms of cabling is therefore not very large.

In contrast, active RFID transponders have a significantly higher range, which may be up to approximately 100 meters, because they draw the energy for supplying the microchip from their own energy store. This energy store can then be fed by the induced voltage of the induction coil of the inductive pulse generator. In this case, the distance between the combined sensor/transmitting unit and the reading device (receiving device) can therefore be significantly larger owing to the relatively large range which can be spanned in a wireless fashion, for which reason substantially longer cable lengths can be avoided with such a solution.

Owing to the energy supplied by the inductive pulse generator or the energy store, the transmitting device is designed to emit, in addition to the rotational speed measurement signal, measurement signals of further sensors, such as a temperature signal of a temperature sensor, a wear signal of a brake lining wear sensor and/or a pressure signal of a pressure sensor, to the receiving device.

More precise details can be found in the following description of an exemplary embodiment.

An exemplary embodiment of the present invention is illustrated below in the drawing and explained in more detail in the following description.

### BRIEF DESCRIPTION OF THE DRAWINGS

The FIGURE shows a measuring device for measuring the relative rotational speed of a rotor which rotates with respect to a stator, according to an exemplary embodiment of the present invention.

### DETAILED DESCRIPTION

The FIGURE shows a measuring device 1 for measuring the relative rotational speed of a rotor which rotates with respect to a stator, according to an exemplary embodiment of the present invention. The stator is composed here of a combined sensor/transmitting unit, of which may be a plurality 2a, 2b to 2n are present. Each of the sensor/transmitting units 2a, 2b to 2n is assigned to a rotor or measures the rotational speed thereof, in particular one per vehicle wheel of a vehicle for measuring the wheel speed. In the text which follows, the design of the sensor/transmitting unit 2n, which includes, inter alia, an inductive pulse generator 4, is explained by way of example for the other sensor/transmitting units 2a, 2b to 2n−1.

The inductive pulse generator 4 serves to incrementally detect the relative rotational speed of what may be one vehicle wheel within the scope of an ABS (anti-lock brake system), TCS (traction control system) or ESP (electronic stability system) with which the vehicle may be equipped. In this context, the vehicle wheel is fitted, for example, with a ring (not shown here) with a number of circumferential markings, for example in the form of teeth of a gearwheel, wherein each tooth brings about a change in voltage of the voltage induced in an induction coil 6 of the inductive pulse generator 4. Evaluation electronics then calculate the relative rotational speed of the vehicle wheel relative to the inductive pulse generator 4 from the number of circumferential markings scanned per time unit or from the signal frequency.

In this context, the ring may be composed of magnetically passive material such as, for example, of soft-magnetic iron. In this case, the induction coil 6 of the inductive pulse generator 4 is wound, for example, about a pole pin to which a magnet 8 made of hard-magnetic material is attached. Alternatively, the ring can also be composed of hard-magnetic material, with the individual teeth of the gearwheel having an alternating magnetic polarity. An electrical voltage which represents a rotational speed measurement signal for the rotational speed of the vehicle wheel is then induced in the induction coil 6 by the rotation of the ring which is provided with circumferential markings and rotates along with the vehicle wheel. The method of functioning of such an inductive pulse generator 4 is sufficiently known, for which reason more details will not be given on it here.

Instead, it is essential that a transmitting device 10 which can be supplied by the electrical energy based on the voltage induced by the inductive pulse generator 4 is provided, which transmitting device 10 wirelessly transmits at least the rotational speed measurement signal, or a signal derived therefrom, to a receiving device 12 which is provided for this purpose with an antenna 14. Said signal which is derived from the rotational speed measurement signal can be, for example, the evaluated rotational speed measurement signal if an evaluation device for the rotational speed measurement signal is already present at the transmitter end, which evaluation device generates from said rotational speed measurement signal the actual rotational speed as a ready input variable for, for example, at least a control unit or for at least a pressure-regulating module.

The receiving device 12 is integrated or arranged, in particular, in the vicinity of the axle in a pressure-regulating module or ABS valve or in a control unit or in a component, such as a ride-level sensor device or rotational speed sensor device, which is arranged on a vehicle frame of a utility vehicle. The receiving device 12 decodes the signals transmitted by the transmitting device 10 of a combined sensor/transmitting unit 2a, 2b to 2n or of the transmitting devices 10 of a plurality of combined sensor/transmitting units 2a, 2b to 2n, and passes on the latter to a brake control unit, for example.

Since the inductive pulse generator 4 may be a rotational speed sensor for measuring wheel speeds within the scope of an ABS/traction control and/or ESP system of a vehicle, a separate combined sensor/transmitting unit 2a, 2b to 2n is arranged, for example, in the direct vicinity of each vehicle wheel, in the present case 1 to n combined sensor/transmitting units 2a, 2b and 2n for n vehicle wheels.

Such a combined sensor/transmitting unit 2a, 2b to 2n transmits the rotational speed measurement signal for the rotational speed of the respective vehicle wheel to the, for example, central receiving device 12, from which the measurement signals are then passed on to an ABS, traction control and/or ESP control unit or to an electro-pneumatic pressure-regulating module (DRM) which is wheel-related or axle-related. In particular, the receiving device 12 can be integrated directly into the control unit or pressure-regulating module.

A combined sensor/transmitting unit 2a, 2b to 2n particularly may contain at least one energy store 16 which can be charged by the induced voltage of the induction coil 6 and has the purpose of supplying energy to the transmitting device 10. This energy store 16 is formed, for example, by at least one maintenance-free capacitor. An accumulator such as, for example, an NiMH, Li-ion or Li polymer accumulator is also conceivable. In order to permit the capacitor 16 to be charged, a pulse shaper 18 for shaping the alternating voltage, generated by the induction coil 6, into a direct voltage for the capacitor 16 may also be integrated in the combined sensor/transmitting unit 2a, 2b to 2n. Furthermore, the induction coil 6 is connected to a signal-conditioning device 20 for converting the analog measurement signal into a square-wave signal, which signal-conditioning device 20 is also connected to the transmitting device 10 which generates an encoded radio signal.

The induction coil 6 of the inductive pulse generator 4, the signal-conditioning device 20 and the transmitting device 10 may then particularly be combined as elements of a signal part of a combined sensor/transmitting unit 2a, 2b to 2n, connected by corresponding signal lines 22, and the energy store 16 and the pulse shaper 18 as elements, connected by corresponding supply lines 24, of a supply part of a combined sensor/transmitting unit 2a, 2b or 2n in a combined sensor/transmitting unit 2a, 2b or 2n which is arranged in the direct vicinity of the ring or the vehicle wheel. The supply part then supplies electrical energy to the signal part, to be more precise the signal-conditioning device 20 and the transmitting device 10 via the supply lines 24. In addition, a signal evaluation device (not shown here) can also be integrated into the sensor/transmitting unit 2a, 2b to 2n which evaluates the square-wave signal, modulated by the signal-conditioning device 20, and generates therefrom an actual rotational speed signal which can be processed directly by a control unit or a pressure-regulating module, and feeds said actual rotational speed signal into the transmitting device 10. Finally, the sensor/transmitting units 2a, 2b to 2n each have an antenna 26 which extends from the transmitting device 10.

According to one exemplary embodiment, the transmitting devices 10 of a combined sensor/transmitting unit 2a, 2b to 2n and the receiving device 12 are part of an RFID system with a what may be an active transponder.

Such an active RFID transponder may then be respectively a component of a combined sensor/transmitting unit 2a, 2b or 2n and then draws the energy for supplying the signal part from the integrated energy store 16.

Owing to the energy supply by the inductive pulse generator 4 or the energy store 16, such a combined sensor/transmitting unit 2a, 2b to 2n can transmit, in addition to the rotational speed measurement signal, further measurement signals of vehicle-wheel-related sensors to the receiving device 12, for example a temperature signal of a temperature sensor relating to the bearing temperature of the vehicle wheel bearings and/or a wear signal of a brake lining wear sensor and/or a pressure signal of a pressure sensor of a tire pressure control. The signals of such sensors are then fed to the sensor/transmitting units 2a, 2b to 2n, for example through cable connections.

Encoded data transmission from the transmitting device to the receiving device 12 makes it possible to avoid a situation in which measuring devices of similar design from different manufacturers influence one another. Finally, the combined sensor/transmitting units 2a, 2b and 2n are each protected from high induction voltages occurring during high-speed travel.

The table of reference numbers is as follows:
1 Measuring device
2 Sensor/transmitting unit
4 Inductive pulse generator
6 Induction coil
8 Coil core
10 Transmitting device
12 Receiving device
14 Antenna
16 Energy store
18 Pulse shaper
20 Signal-conditioning device
22 Signal lines
24 Supply lines
26 Antenna

1-10. (canceled)

11. A measuring device for measuring a relative rotational speed of a rotor which rotates with respect to a stator, comprising:
at least one inductive pulse generator, which is supported by the stator and which includes at least one induction coil in which an electrical voltage, which represents a rotational speed measurement signal for the rotational speed of the rotor, is induced by the rotation of the rotor provided with circumferential markings; and
a transmitting device, which receives the electrical energy based on the voltage induced by the inductive pulse generator, to transmit wirelessly at least one of the rotational speed measurement signal and a signal derived therefrom to a receiving device.

12. The measuring device of claim 11, wherein at least one energy store, which can be charged by the induced voltage is provided at least for supplying energy to the transmitting device.

13. The measuring device of claim 12, wherein the energy store includes one of (i) at least one maintenance-free capacitor, and (ii) an accumulator.

14. The measuring device of claim 12, wherein at least one pulse shaper shapes the alternating voltage, which is generated by the induction coil, into a direct voltage for the energy store.

15. The measuring device of claim 11, wherein the inductive pulse generator includes a signal-conditioning device for converting the analog measurement signal into one of a square-wave signal and a data signal.

16. The measuring device of claim 11, wherein at least the inductive pulse generator, the energy store, the pulse shaper, the signal-conditioning device and the transmitting device are combined in a combined sensor/transmitting unit, which is arranged in the direct vicinity of the rotor.

17. The measuring device of claim 16, further comprising:
a receiving device for the combined sensor/transmitting unit, from which the measurement signals are passed on to at least one of (i) at least one control unit, (ii) one pressure-regulating module, and (iii) one ABS valve.

18. The measuring device of claim 11, wherein the transmitting device and the receiving device are part of an RFID system with one of an active transponder and a passive transponder.

19. The measuring device of claim 11, wherein the inductive pulse generator is a rotational speed sensor for measuring at least one of wheel speeds within the scope of one of an ABS/traction control and an ESP system, crankshaft rotational speeds, camshaft rotational speeds, and rotational speeds of an injection pump of a vehicle.

20. The measuring device of claim 11, wherein the transmitting device is configured to emit, in addition to the rotational speed measurement signal, measurement signals of further sensors, including at least one of a temperature signal of a temperature sensor, a wear signal of a brake lining wear sensor, and a pressure signal of a pressure sensor, to the receiving device.
